(19) United States
(12) Patent Application Publication
(10) Pub. No.: US 2018/0167698 A1
(43) Pub. Date: Jun. 14, 2018

(54) INSTANT CLIP CREATION BASED ON MEDIA CONTENT RECOGNITION

(71) Applicant: Cooler Technologies, Inc., Venice, CA (US)

(72) Inventors: Jason Christopher Mercer, Venice, CA (US); Jason Weiss, Los Angeles, CA (US); Kenneth Keegan, Culver City, CA (US); Bea Metitiri, Culver City, CA (US); Ashley McAtee, West Hollywood, CA (US)

(21) Appl. No.: 15/839,314

(22) Filed: Dec. 12, 2017

Related U.S. Application Data
(60) Provisional application No. 62/432,899, filed on Dec. 12, 2016.

(51) Int. Cl. H04N 21/854; G06K 9/00; H04N 21/84; G06F 17/30

(52) U.S. Cl. CPC H04N 21/854; G06F 17/30784; H04N 21/84; G06K 9/00744

(57) ABSTRACT

Provided is a computer implemented method for preparing a clip of one or more of a video or an audio content, comprising the steps of a) receiving an input from a user indicating a desire by the user to create a clip of the content; b) identifying of the media content and a specific time within the content the user is watching or listening to based on the digital content of the content or a digital signal associated with the content having identification information; c) creating the clip based on the specific time with a start and an end point; and d) delivering the clip (final clip) to the user. The identification can be carried out by an Automatic Content Recognition (ACR) program using one or more of pre-processed video and audio in the library as a reference for identification. Provided is a computer implemented method for preparing a clip of a media content, comprising: a) receiving an input from a user indicating a desire by the user to create a clip of a media content the user is watching or listening to; b) forwarding a portion of, the content or a digital representation thereof for purposes of identification of the content; e) identifying the content and specific time of the content by Automatic Content Recognition (ACR) based on a digital fingerprint of the content or a digital signal associated with the content having identification information, the identifying performed by comparing the fingerprint or the signal information with fingerprints of pre-processed contents on a library; d) delivering a representative clip to the user on a screen of an electronic device, the clip displayed as part of a graphical interface to the user; e) receiving editing information from the user on the representative clip, the user having an option to modify start and end time of the representative clip; f) creating the clip based on the editing information provided by F the user; and g) delivering the clip to the user.

### CROSS-REFERENCE

The present application claims the benefit of provisional Appl. No. 62/432,899, filed on Dec. 12, 2016, which is incorporated herein by reference.

### BACKGROUND

Media companies spend tens of billions of dollars each year promoting their broadcast, streamed, and downloadable content, including premium television, film, music, podcasts, sports, and gaming competitions, as well as user-generated video and audio. The amount of such content produced and distributed has been increasing every year, and more frequently, this content is consumed on-demand rather than at scheduled broadcast dates and times. Both the growing abundance of content and the pattern of asynchronous audience consumption have decreased the effectiveness of traditional paid promotion techniques of media companies. Further, brands that associate themselves with this content are also finding decreased impact from their marketing efforts as audiences become more fractionalized and as more viewers migrate to platforms that rely on subscription revenue rather than advertising sponsorship.

With these increasing marketing challenges, media companies are seeking ways to generate more organic promotion. The most effective method for increasing consumers' awareness and interest in specific media content is through word-of-mouth from fans of said content within their social circles or followers. Unfortunately, authentic “word-of-mouth” recommendations are challenging to solicit and methods of sharing are often awkward, not compelling, or actively avoided for fear of spoilers.

In addition to media companies, users are seeking ways to generate publicity and share mutual experiences with other users. There is a need in the art to allow and encourage users to promote media content.

### SUMMARY OF THE INVENTION

Provided is a computer implemented method for preparing a clip of a media content, comprising: a) receiving an input from a user indicating a desire by the user to create a clip of a media content the user is watching or listening to; b) forwarding a portion of the content or a digital representation thereof for purposes of identification of the content; c) identifying the content and specific time of the content by Automatic Content Recognition (ACR) based on a digital fingerprint of the content or a digital signal associated with the content having identification information, the identifying performed by comparing the fingerprint with fingerprints of pre-processed contents on a library or by decoding the signal information; d) delivering a representative clip to the user on a screen of an electronic device, the clip displayed as part of a graphical interface to the user; e) receiving editing information from the user on the representative clip, the user having an option to modify start and end time of the representative clip; f) creating the clip based on the editing information provided by the user; and g) delivering the clip to the user. The method can include recording a portion of the content with a microphone or a camera, forwarding the recorded portion of the content watched or listened to by the user or a digital representation thereof for purposes of identification of the content.

Provided is a computer implemented method for preparing a clip of one or more of a video or an audio content, comprising the steps of: a) receiving an input from a user indicating a desire by the user to create a clip of the content; b) identifying of the media content and a specific time within the content the user is watching or listening to based on the digital content of the content or a digital signal associated with the content having identification information; c) creating the clip based on the specific time with a start and an end point; and d) delivering the clip (final clip) to the user. The method can include delivering a representative clip to the user and receiving editing information from the user on the representative clip before the step of creating the and delivering the final clip to the user. The editing information received from the user can include changing one or more of the start or the end point of the representative clip. The method can include adding additional content to the final clip not present in the representative clip due to the instructions from the user for an earlier start time or a later end time. The method can further comprise a step of synchronizing with the content before the step of receiving the input from the user indicating the desire by the user to create the clip. The method can further comprise a step of synchronizing with the content upon receiving the input from the user indicating the desire by the user to create the clip. The identifying can be carried out by listening to the digital signal from a provider of the content. The identifying step can be carried out by making a comparison with a library of pre-processed content. The identifying can be carried out by an Automatic Content Recognition (ACR) program using one or more of pre-processed video and audio in the library as a reference for identification. The library can contain reference frames and fingerprints of the content, and the reference frames and the fingerprints correspond to each other with a time code. The identifying step can be carried out by a) fingerprinting the content, the fingerprinting carried out on the user's device, b) comparing the fingerprints of the content with preexisting fingerprints on the library, the comparing step carried out on a server. When the content is live streamed, and the method can further comprises continually processing the live content and updating the library with one or more of the processed video and audio of the content. The content can be selected from the group consisting of one or more of a looping visual, video segment, virtual reality footage, 3-D footage, still image, or audio sample, and a combination thereof. The method further comprise providing a graphic user interface with controls to the user configured to allow the user to adjust the start and the end point of the representative clip. The final clip or the representative clip can be created from content residing on the user's electronic device. The method can include receiving content on the device of the user to create a buffer of the content on the user's device before receiving the input from the user to create the clip.

Provided is a system for preparing a clip of a media content, the system comprising: a) a content detection module for forwarding content for identification; b) a content identification module for identifying the content; c) a clip creation module for creating a representative and a final clip based on the identification and time the content; d) a content display module for displaying the representative and the final clip to the user; wherein the system provides the representative clip to the user based on an input by the user, and provides the final clip to the user after receiving editing instructions from the user on the representative clip. The system can further comprise a library with digital fingerprints on pre-existing content, wherein the identifying is carried out by comparing the content with the digital fingerprint of the pre-existing content in the library.

Provided is a method and system for preparing a clip of a media content, which comprises: a) receiving of input from a user indicating a desire by the user to create a customized clip of a media content; b) identifying of the media content and specific offset from the start time of the media that is playing on the user's primary device; c) delivery of a representative clip to the user; d) receiving of editing information from the user on the representative clip, e) creating of the customized clip and f) delivering of the clip to the user for sharing or syndications purposes.

Media content can include television programs, news broadcasts, sports broadcasts, concerts, specials, variety shows, movies, online videos, music videos, video lectures, music, podcasts, radio, animation, video games, gaming competitions, among others. If visual, it may be displayed on a screen (e.g., television, computer monitor, tablet, phone or other handheld device) or within a three-dimensional (e.g., an augmented or virtual reality) environment.

The clip generated may be a looping visual (e.g., animated GIF), video segment, VR (virtual reality) footage, 3-D footage, still image, or audio sample, or a combination of the above.

The user may indicate the desire to create a clip from the primary media device on which the media content is playing or from a second screen device. A primary media device can be a television, monitor, laptop computer, tablet, headset, glasses phone or other playback apparatus. A second screen device has no physical relationship to the primary screen device, but it does possess the following characteristics 1) network enabled, 2) able to install dedicated applications or plugins, 3) input sensors such as cameras, microphones, GPS (global position system) receivers, 4) a screen(s) that can display a media editing environment 5) user input facilities such as a touch screen, keyboard, mouse.

For primary media device interaction, where the clip creation system and the content playback are located on the same system or network, the clip creation API (Application Program Interface) can communicate directly with the content playback system via a beacon or other method to identify the source content, metadata and precise current offset of the media segment requested by the user. For second screen device interaction, the clip creation system utilizes Automatic Content Recognition (ACR) to precisely identify the media content and offset with a number of potential systems: audio recognition using the device microphone or other audio sensor, image recognition using the device camera or other visual sensor, or a combination. As a fallback, the user can also manually indicate the content source and time offset.

When the user initiates clip creation process, the system already may be synchronized to the content (e.g., recognizes the content and precise offset using beacons or ACR). If the device is not synced, the system will first synchronize to the source content and then initiate the clip creation process.

When the user initiates clip creation process, the system creates a representative clip based on the identified content and offset playing on the user's primary device. The default representative clip parameters may be 1) configured by the system administrator, 2) determined based on pre-set specifications for the type of media content (e.g., the parameters for a scripted television show being different than for a sporting event) or 3) determined by the user in their personal settings. These parameters will consist at least of a start and end point for the clip relative to the user's current offset. For instance, the representative clip may be three seconds long, starting from four seconds before user initiated the clip creation process and ending one second before the user initiated the clip creation process. Or the representative clip may start at the same moment the user initiated the clip creation process and end five seconds later. The representative clip may be generated on the user's device (the client module) or remotely (the server module). The method may provide a buffer of a pre-determined length of representative media to the client module that is continually updated to match the media playing on the primary device. This buffer of representative media content can be used to generate the representative clip when the user initiates the clip creation process. Alternatively, the representative frames can be delivered to the client module after the user initiates the process or the clip can be generated in the server module.

Once the representative clip has been created, the system makes it available to the user for review and editing. The representative clip can be sent to the client module on the user's device, or it may be accessed on a remote server (e.g., the cloud) by the user through a connected device. The user can modify the start point and the end point in the representative clip. The specified start point can be earlier than the start point in the reference clip; the system allows the user to navigate to any earlier offset in the media content and designated it as the start point for the customized clip. The designated end point can be later than the end point in the reference clip; the system allows the user to navigate to any late offset in the media content and designated it as the end point for the customized clip. There may be a maximum clip duration (e.g., 10 seconds) that limits the differential between the two endpoints. The user can add visual or audio filters or other stylings to the clip and can further customize it by including and styling commentary text, dialogue, emoji, badges, virtual stickers, doodles, characters, animations, decorations or other images, audio and video atop or alongside the clip. The representative clip can be discarded and the process restarted.

When the user has finished specifying customizations to the representative clip, the user commits the creation, sending a signal to the system to generate the customized clip. The customized clip'may be a looping visual (e.g., animated GIF), video segment, VR footage, still photo, or audio sample. The system then creates the customized clip, either on a remote server or the user's local primary or secondary device. If the customized clip is created on a remote server, it is delivered to the user's device. If the customized clip is created on the user's local device, the resulting creation is pushed to the server.

Once the customized clip has been created and delivered, the user can share the clip and via digital means, including email, blogs, videos, SMS or MMS texts, podcasts or social and messaging platforms. The customized clip may include advertising integrated with or atop the clip.

The customized clip can also be delivered to other users of the system, such as those who have subscribed to the user's feed of clips or potentially to all users within a curated feed. Users can favorite the clip, comment on the clip, share, download, save, or duplicate the clip and customize it themselves. Users can opt to apply spoiler protection to clips so that the clip is obscured if a second user hasn't seen the source content yet. A second user can override the spoiler protection at their own choosing.

### BRIEF DESCRIPTION OF THE DRAWINGS

FIG. 1 illustrates network architecture.

FIG. 2A illustrates clip creation flow for User 1—One Step—simultaneous sync and create action.

FIG. 2B illustrates clip creation flow for User 1—Two Steps—sync first and then create.

FIG. 3A illustrates an Application user interface for creating a clip.

FIG. 3B illustrates an Application user interface for customizing a clip.

FIG. 4 illustrates sharing of a created clip and actions by other users on the clip that has been shared.

FIG. 5A illustrates system processing pre-recorded content.

FIG. 5B illustrates system processing live/streaming content.

FIG. 6 illustrates typical components of a user's device.

FIG. 7 illustrates a final clip.

### DETAILED DESCRIPTION OF THE INVENTION

The invention relates to a method and system for allowing a media consumer to generate, customize and share a segment (or “clip”) of content they are currently consuming from an external source based on a content recognition system.

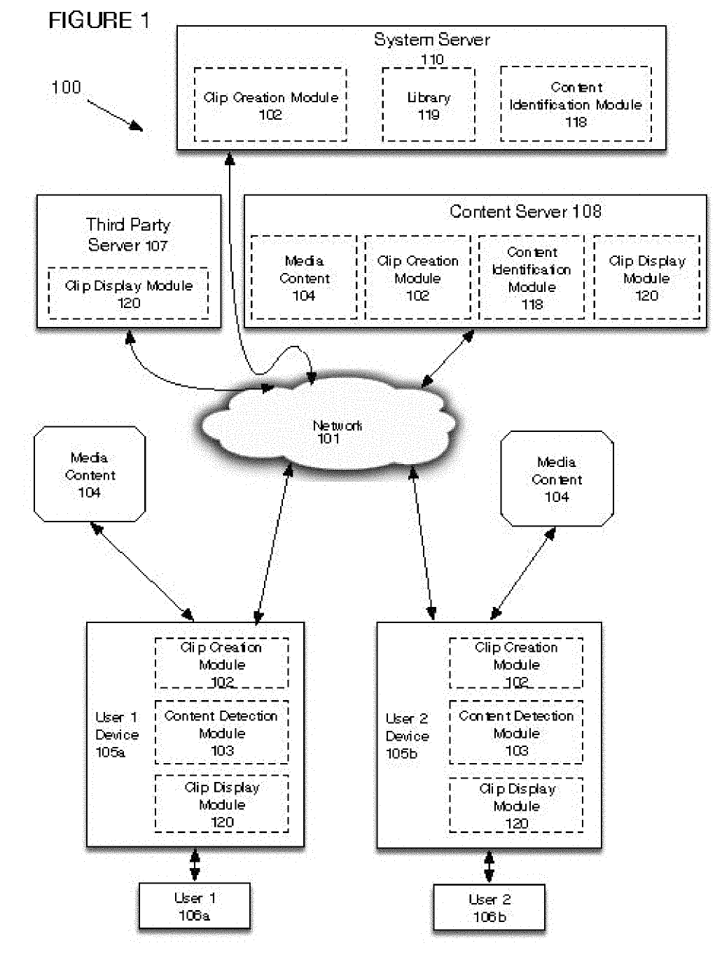

FIG. 1 illustrates a block diagram of implementation of system 100 for processing clips and creating clips. As shown in FIG. 1, a network or cloud-based system 101 can connect various devices and modules thereon, on which a process to control viewing of clip delivery can be carried out. The network 101 can be a wired or wireless public network (such as ‘the internet’) or a closed (such as private) network. Examples of networks include conventional type, wired or wireless, and may have numerous different configurations, such as star or token ring. Communication can be carried out through a network capable of carrying out communication under one or more of GSM, CDMA, or LTE (tower) protocols, or other multiple access technology protocols. The devices can be configured to communicate with a mobile tower or a local wireless network (WiFi, LAN).

Clip creation module 102 can be an application that allows users to create clips of media content. The clip creation module 102 need only to be present on a server such as system server 110 or the user's device 105. Clip creation module 102 can also be present on a content server 108. The media content as illustrated in FIG. 1 can be either free standing content (such as one a movie screen) 104 or shown as by a content server 108 (such as Netflix®) that can also host clip creation module 102. The clip creation module 102 can be used to create a clip either on the user's device 105, content server 108, or system server 110. The clip creation module 102 can make both a representative clip for the user to edit, and a final clip with or without the user's edits.

Media content 104 can be played on the same device 105 on which the user is running the clip creation module 102 (e.g. a smart phone, laptop, tablet, virtual reality headset or smart TV), or it could be a separate, secondary device (e.g. the clip creation module 102 is on a phone, and the content is being played on a TV, monitor, tablet, VR headset, or other device). The content 104 can be broadcast, live-streamed, or pre-recorded. Users 106a, 106b can be interacting simultaneously and in physical proximity, or across great distances and at completely different times.

Clip display module 120 can be used to view, listen to, or otherwise consume clips that have been created by the same or different users using clip creation module 102. Clip display module 102 can reside on a user's device 105, allowing the user to consume the clip on the user's device. Alternatively, the clip display module can be on the content server 108 or a third party server 107. Clip display module 120 on the content server 108 allows a user to display a clip of the content 104 that is playing on the content server 108, and to consume and/or share the clip. Clip display module 120 on a third-party server allows a user to share a prepared clip on the third-party server 107 that does not play media content as its primary function, e.g., posting a clip on Twitter®.

Content identification module 118 identifies the media content and detects the specific time (time offset or time code) within the media content. Content identification module 118 can rely on a number of methods to identify the actual media content 104, including audio fingerprinting, video fingerprinting, combination fingerprinting, direct signal (signal beacon), and manual designation. The detection can be automatic, or determined by active user input. When the detection is automatic, ACR (Automatic Content Recognition) can be used, which samples video, and/or audio using the content detection module 103. The content detection module 103 uses a camera 611 and/or microphone 612 on a user's device 105 to send samples of video and/or audio to the content identification module 118, which then identifies the media content and determines the exact time when a clip creation was requested. Alternatively, the automatic detection can be done by reading a signal (via a beacon or other methods) having time and optionally identity information about the media content, and linking the clip creation to the time provided by the signal. In the active user input method of detection, a user may decide to manually override the system and request clip creation for a time after or before the user's progress relating to media content 104. In this method, the user identifies the media content and the time for clip creation. The content detection module 103 can be placed on the user's device to detect and identify the media content. Alternatively, the Content detection module 118 can be on the system server 110 or a content server 108.

The system can include a system server 110. The system server 110 can have a clip creation module 102, which creates desired clips based on the time provided by the content identification module 118. The system server 110 can act as an interface between one or more of the third-party server 107, content server 108, and the user's device 105. System server 110 can for example interface between clip creation module 102 and content identification module 118, resulting in clip creation module 102 receiving time data from the identification detection module 118 (regardless of location of 102 and 118). System server 110 can also act as an interface for clip creation module 102 that is outside of system server 110, such as on user device 105a/b. System server 110 can also act as an interface for clip display module 120 that is inside/outside of system server 110, such as on user device 105a/b. The system server 110 can periodically communicate with the clip display module 120 in a remote location to update the clip display module 120 and to optionally embed or serve advertising on the clip display module 120 on the user's device 105.

System server 110 can also have library 119. Library 119 can include pre-existing content that has been identified and fingerprinted. Library 119 allows content identification module 118 to compare audio and/or video samples forwarded by content detection module 103 and make an identification by comparison of the samples with the content existing in the library 119.

A third-party server 107 or content server 108 can embed or connect with clip display module 120. A social network application (e.g. Facebook®, Twitter®, Tumblr®, Reddit®, Instagram® among others) on a third-party server 107 can embed clips into posts, messages, chats, stories, lists, and other content. A server for a third-party publisher 107 (e.g. New York Times among others) can also embed clips into their stories, articles, posts, comments, lists, etc. A system server 110 for playing back content can also have a clip display module 120 integrated directly into the playback experience.

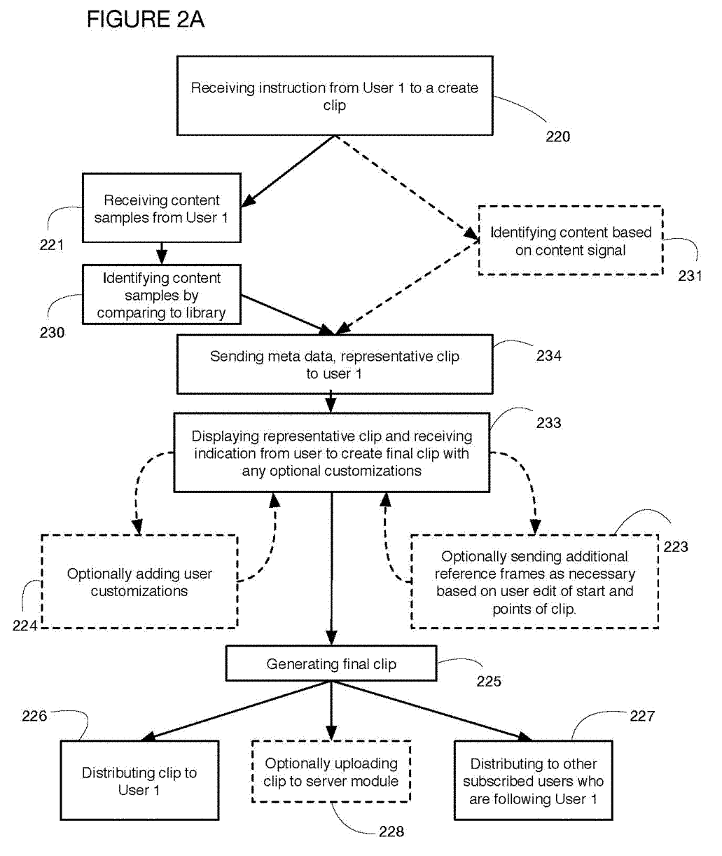

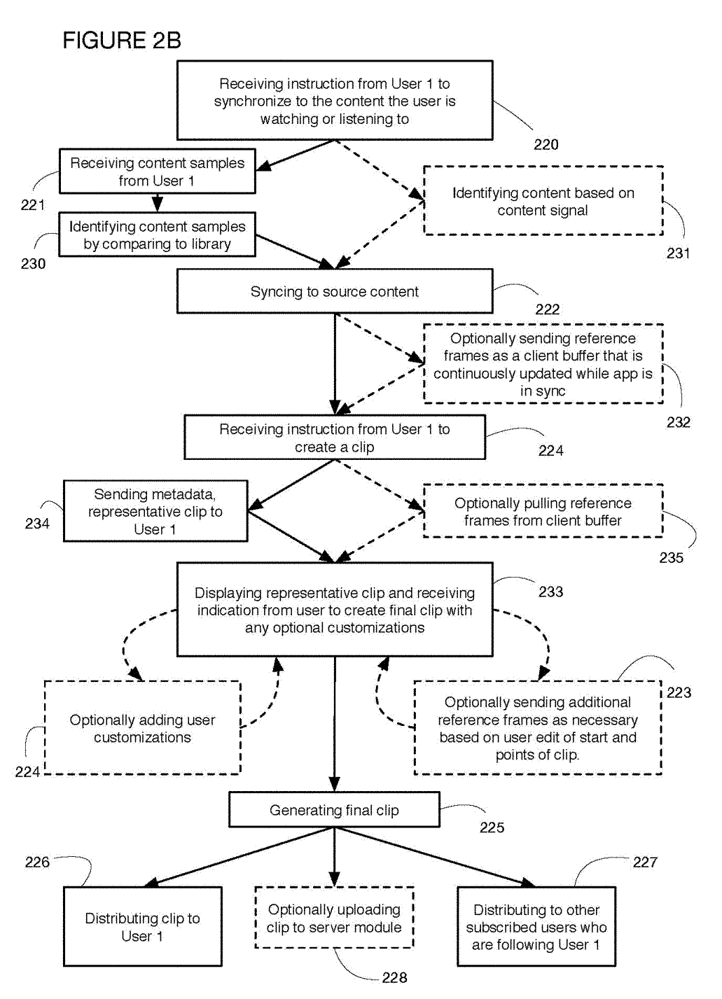

FIG. 2A illustrates a computer implemented process for creating clips with inputs from a user using digital synchronization with a media content that User 1 is watching or listening to. The system receives instructions (typically from a user interface interaction on user device 105 or content server 108) from User 1 to create a clip 220 of a media content (such as a video, television program, film, sporting event, or podcast) that User 1 is watching or listening to. The clip creation module 102 can be opened in response to the instruction by User 1.

User 1's device 105, specifically the application thereon, sends content samples 221 or other identifying information to the system server 110. The system server 110 then identifies the media content 230 by comparing the samples with preexisting content fingerprints in the library 119. The sample can be an actual video and/or audio segment or streams or a digital representation (fingerprint) thereof. If there is a content signal (e.g., beacon) from a content server 108, the system server 110 can identify the media content based on the beacon 231. After identifying the media content, the system server 110 sends metadata (e.g., title, season, episode, timecode) and a representative clip to User 1 234. The system displays the representative clip to User 1 and receives an indication from User 1 to create a final version of the clip 233. Before receiving'an indication from User 1 to create a final version of the clip, User 1 can optionally modify the start and end points of the clip. The system server 110 sends additional reference frames (additional content) 223 to User 1 as necessary if User 1's edits require additional content prior to the start point or later than the end point of the representative clip. Before receiving an indication from User 1 to create a final version of the clip, User 1 can optionally add customizations to the clip 224 to personalize it. The system creates a final clip 225. The final clip can be created in the cloud or, on User 1's device 105 or on content server 108. If the final clip is created on User 1's device 105 or content server 108, the final clip can be uploaded on the system server 110 before distribution to users 228. The final clip can be distributed to User 1 226 and other subscribers who follow User 1 227.

FIG. 2B illustrates a computer implemented process for creating clips where a synchronization step occurs first. The system receives instructions from User 1 to synchronize to the media content that User 1 is watching or listening to 220. To synchronize, the system first identifies the media content and the specific time within the content User 1 is watching or listening to. The identification can be done in the same manner is FIG. 2A (221, 230, 231). The system is then synchronized to the content User 1 is watching or listening to 222. If the system is configured to create a buffer on User 1's device 105 or content server 108, the system continuously sends reference frames (additional content) to User 1's device or the content server 108 and updates the reference frames as User 1 is watching or listening 232. The buffer allows User 1 to create a clip locally based on the buffer content that is present on User 1's device or content server, minimizing time lag by eliminating communication to a server. The system receives signal from User 1 to create a clip 224. Because the content has been identified and is synchronous, an identification step is typically not needed. On some occasions, the system may perform an identification step if deemed necessary. The system sends metadata (e.g., title, season, episode, timecode) and a representative clip to User 1 234, or if the buffer exists, User 1's device or content server creates the representative clip by pulling the content from the buffer 235. The rest of the process is the same as described in FIG. 2A (233, 223, 224, 225, 226, 227, 228).

A client/server configuration can be used to make the representative or final clip. The client module (user device 105) displays the clip and receives User 1's confirmation on start and end points. Optionally the client module (system server 110) pulls additional reference frames as necessary based on User 1's edit of start and end points of clip. The server module receives indication from User 1 to create final clip with any optional customizations. The server module generates final clip on a server or in the cloud, and distributes clip to User 1 and/or distributes to other subscribed users who are following User 1. Optionally, the client module generates final clip and displays to User 1, the client module uploads clip to the server module, and/or the server module distributes to other subscribed users who are following User 1.

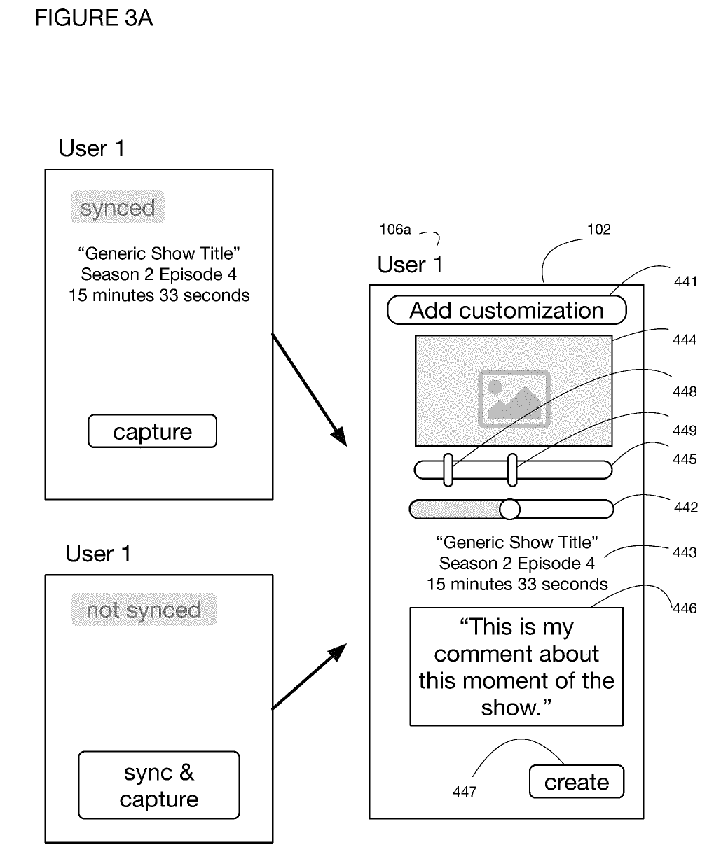

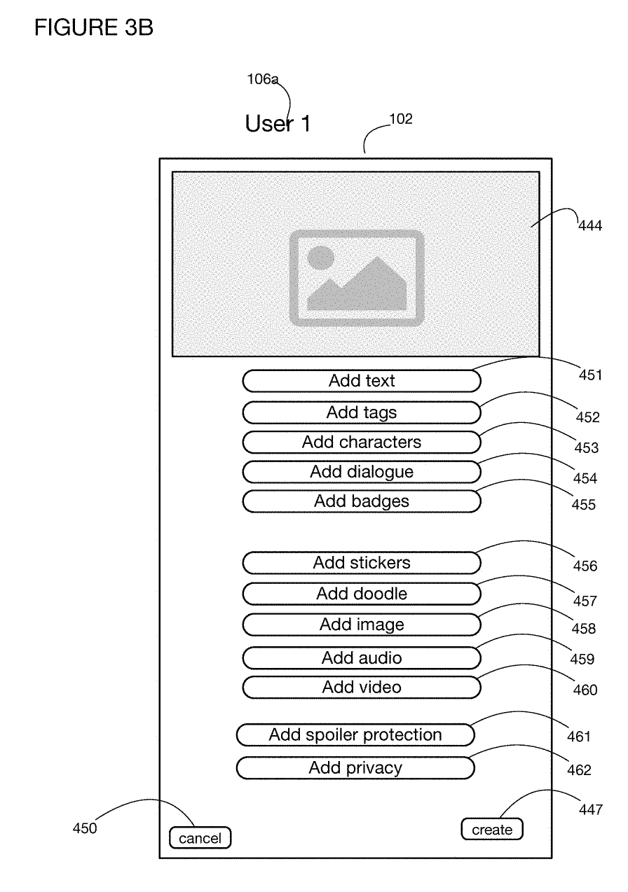

FIG. 3A illustrates the process of requesting, customizing and creating a clip on the screen of an electronic device with a graphical user interface. In this case, the system has received instructions from User 1 to create a clip 220. The system optionally can be previously synchronized with the media that User 1 is watching or listening to on an electronic device, such as live media broadcasted on a separate device playing media content 104 or content server 108. If the system is not synchronized, the system first synchronizes upon receiving a request us create a clip. The system creates a representative clip 444 based on the identified content and the specific time 443 within the content when the clip creation was requested. The specific time can be measured to the second or even more granularly (e.g., to 1/10th or 1/100th of a second). The representative clip is made around the specific time 443. Typically, the start and end points of the representative clip both occur before the specific time 443 when the creation request was made. For example, if the request was made at time 10, the representative clip could have a start time of 5 and an end time of 9 to account for the fact that User 1 likely gave instructions to create a clip after seeing or hearing a segment of content from which they desired to create a clip.

The system makes the representative clip 444 available to User 1 for review and editing, optionally including the content identification info (e.g., title, season, episode, timecode) 443. User 1 can modify the start point 448 and the end point 449 of the representative clip with controls provided on the screen. The control can be a button, a slider, or a window that allows a user to scroll through the representative clip. The specified start point 448 can be earlier than the start point in the representative clip. The specified end point 449 can be later than the end point in the representative clip. There may be a maximum clip duration (e.g., 10 seconds) that limits the differential between the two endpoints. The user can add a comment 446 that is be associated with the clip.

User 1 can optionally customize the clip 441. As illustrated in FIG. 3B, User 1 can add visual or audio filters or other stylings to the representative clip 444 and can further customize it by including and styling text 451 (e.g., “meme text”), tags 452, characters 453, dialogue 454, badges 455, virtual stickers 456, doodles 457, or other images 458, audio 459 and video 460 atop or otherwise associated with the clip. User 1 can optionally apply spoiler protection 461 to the clip to prevent other users of the system from seeing or hearing the clip if they haven't yet seen or heard that portion of the media content. User 1 can apply different privacy options to the clip that impact visibility to other users 462. The representative clip can be discarded and the process restarted 450. When User 1 has completed the optional customizations, User 1 taps on the create button 447 or similar mechanism to create a final clip.

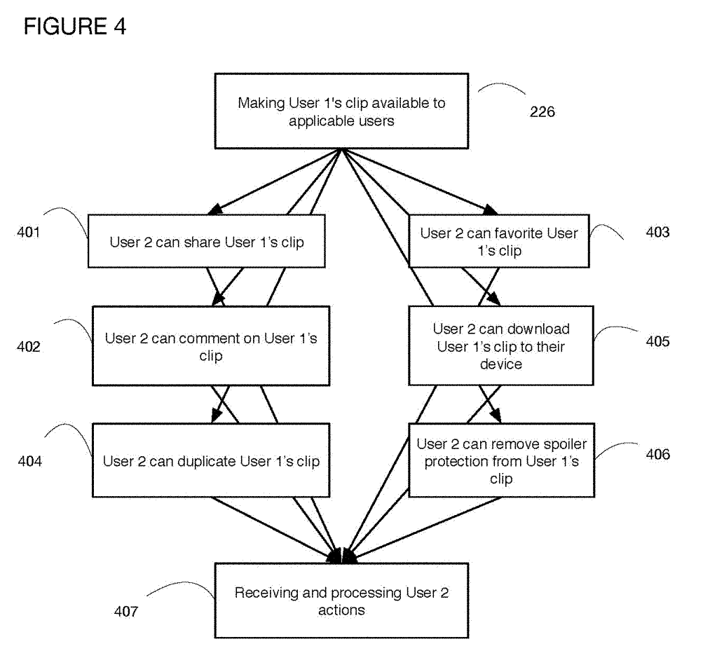

FIG. 4 illustrates the actions a second user (User 2) can take in relation to a clip created by a first user (User 1), which is made available to other users 226. A final clip created by User 1 can be visible to other users of the system, such as those who have followed User 1 (e.g., User 2). User 2 can optionally share 401, comment on 402, favorite 403, or download 405 User 1's clip. User 2 can optionally duplicate 404 User 1's clip and optionally customize the clip as described in FIG. 3. If User 2 duplicates and optionally customizes the clip, the system creates a new final clip that is owned by User 2. If User 1 has applied spoiler protection to User clip and the clip is obscured, User 2 can optionally remove the spoiler protection 406. For each of these optional actions by User 2, the system receives and processes the relevant information 407.

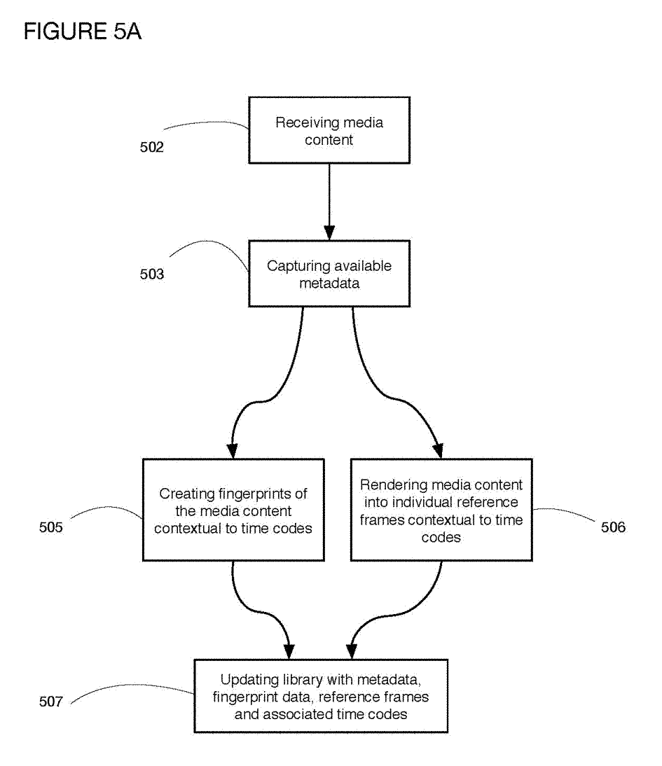

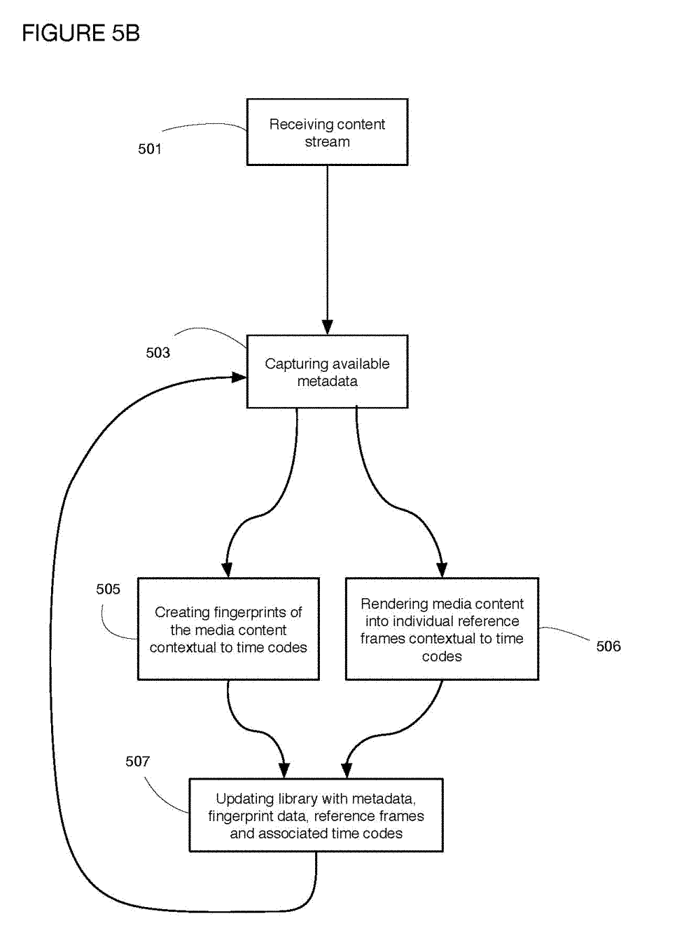

FIG. 5A illustrates the system ingesting pre-recorded media content for purposes of future content identification and clip creation. The system receives a media content 502 as a complete element (e.g., recording, file). The system captures available metadata 503 from the media content, possibly including title, season, episode, run time, original air date, content owner, and other relevant information. The system creates audio and/or video fingerprints 505 of the recording. Fingerprints are concise digital summaries that are deterministically generated from an audio or video signal that can be used to identify an audio or video sample. Fingerprinting can use software to identify, extract, and/or compress characteristic components of a video or audio content. The system continuously makes fingerprints of the content and stores them in the library along with the specific moment time code) for each fingerprint. When ACR matches a sample of a content to a fingerprint, it returns both the indentifying information of the content as well as the time code within the content where the sample exists.

The system also renders media content into individual reference 506 frames that can be used to create representative and final clips. In case of video content, each reference frame can be a single still image that is later combined with other still images to make a clip. Each reference frame can have a time code corresponding to the specific time within the content where the reference frame exists. The system can link a reference frame with a fingerprint based on a mutual time code. The system updates the library 119 with metadata, fingerprint data, and reference frames along with associated time codes 506. Library 119 can contain processed media content with fingerprint data and reference frames, with each fingerprint data and reference frame linked together through a common time code within the media content.

FIG. 5B illustrates a process that is similar FIG. 5A except that the content is provided to the system in a live, streaming format instead of as complete content element (e.g. recording, file). In this case, the system initially updates its database with metadata 503. The system continually generates fingerprints 505 and individual reference frames 506 of the live or streamed media content (as well as associated time codes) as it is received and processed. The system continually updates 507 the library 119 with the fingerprint data and reference frames as the live or streamed content is received and processed. The system continuously updates the library even if the user does not request creation of a clip while the media content is being ingested.

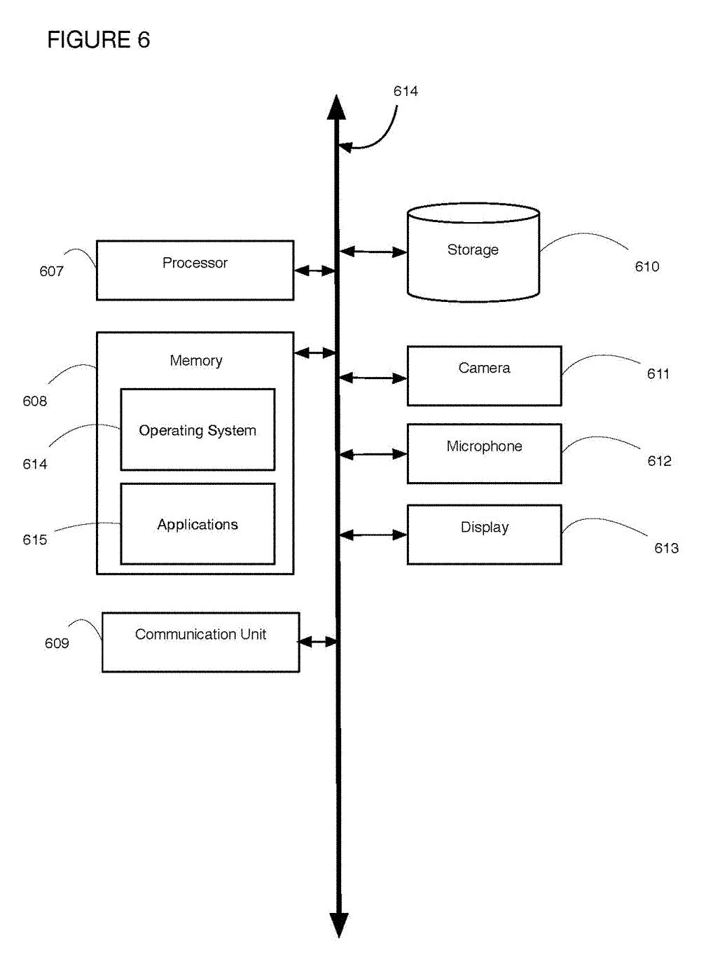

FIG. 6 illustrates user device 106b. FIG. 6 is an example of a computing device that includes a processor 607, memory 608, communication unit 609, storage 610, camera 611, microphone 612, and display 613. The processor 607 can include an arithmetic logic unit, a microprocessor, and/or other processor arrays to perform computations. The processor can for example be a 64-bit ARM based system on a chip (SoC). The memory 608 stores instructions and/or data that may be executed by processor 607. The memory can be volatile and/or non-volatile, and can include static and dynamic random access memory (DRAM) (SRAM), flash memory, or a hard disk drive. The communication unit 609 transmits and/or receives data from at least one of the user's device 105, the third-party server 107, the content server 108, and the system server 110. The communication network can be configured to communicate with through wired or wireless communications. The storage device 610 can be non-transitory memory that stores data, particularly data describing activities (such as progress stage) by one or more users. The storage device 610 can store posts and/or comments published by one or more users, time frame of posts/comments, progress stage of users, and whether or not a user has viewed a clip. In addition, the electronic device, can have a camera 611, microphone 612, and display 613. A server can have the same components other than camera 611, microphone 612, and display 613. Various modules 614 as illustrated in FIG. 1 can be on the electronic device 105 or any of the servers (such as applications 615). The electronic device or the server can haven on operating system 614 and various applications 615 that are placed on memory 608, and are accessible for execution by processor 607.

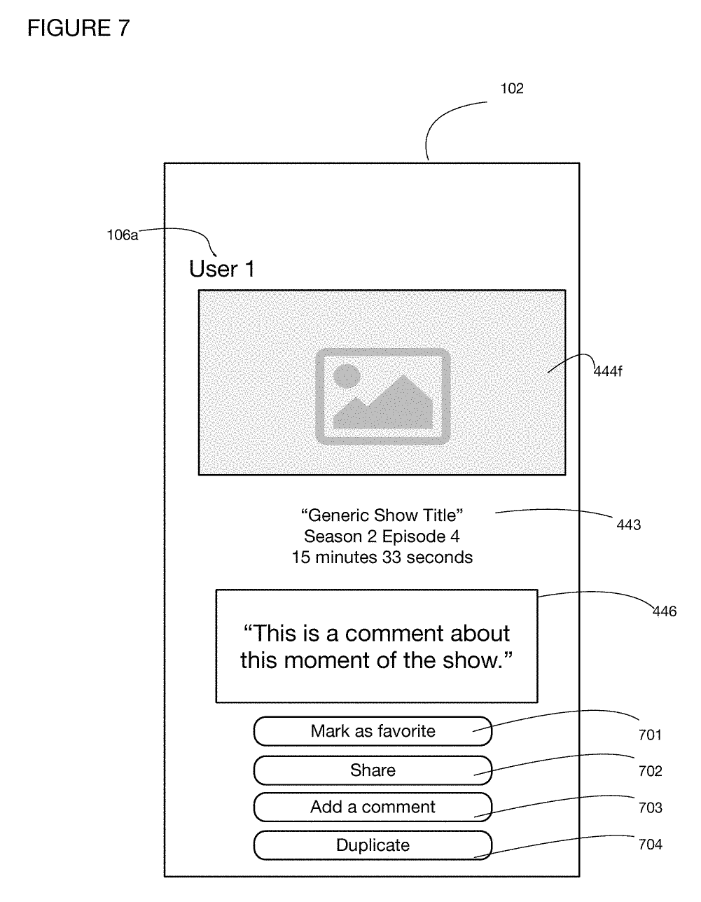

FIG. 7 illustrates a final clip 444f. The final clip is like the representative clip except that its start and end points, and any customizations that it has, are set in place and cannot be edited by the user. The final clip can be played/paused by tapping on the screen. A user can see comments 446 and the specific time 443 associated with the final clip 444f, and further mark as favorite 701, share 702, add a comment 703, or duplicate 704 the clip.
100 System
101 Network
102 Clip creation module
103 Content detection module
104 Media Content
105 Device
106a, 106b Users
107 Third party server
108 Content server
110 System server
118 Clip creation server
119 Library
120 Clip display module
220 Receiving instruction to synchronize
221 Receiving content samples
223 Sending additional reference frames
224 Adding customization
225 Creating final clip
226 Distributing or making available clip
227 Distributing clip
228 Uploading clip
401 Share clip
402 Share reaction
403 Favorite
404 Duplicate
405 Download
406 Remove Spoiler
407 Receive and process actions by other users
442 Timeline
443 Specific time
444 Representative clip
444f Final clip
445 Control bar
446 Comment
447 Create clip
448 Start Point
449 End Point
450 cancel
451 Add text
452 Add tags
453 Add characters
454 Add dialogue
455 Add badges
456 Add stickers
457 Add doodle
458 Add image
459 Add audio
460 Add video
461 Add spoiler protection
462 Add Privacy
501 Receiving content stream
502 Receiving media content
504 Generating timecode for media
505 Creating media fingerprints of the recording relative to timecode
506 Rendering media into individual reference frames relative to timecode
507 Updating database with content id, fingerprint data, timecode and reference frames
607 Processor
608 Memory
609 Communication unit
610 Storage
611 Camera
612 Microphone
613 Display
614 Operating Systems
615 Applications
614 Bus
701 Mark as favorite
702 Share
703 Add a Comment
704 Duplicate

What is claimed is:

1. A computer implemented method for preparing a clip of a media content, comprising: a) receiving an input from a user indicating a desire by the user to create a clip of a media content the user is watching or listening to; b) forwarding a portion of the content or a digital representation thereof for purposes of identification of the content; c) identifying the content and specific time of the content by Automatic Content Recognition (ACR) based on a digital fingerprint of the content or a digital signal associated with the content having identification information, the identifying performed by comparing the fingerprint with fingerprints of pre-processed contents on a library or by decoding the signal information; d) delivering a representative clip to the user on a screen of an electronic device, the clip displayed as part of a graphical interface to the user; e) receiving editing information from the user on the representative clip, the user having an option to modify start and end time of the representative clip; f) creating the clip based on the editing information provided by the user; and g) delivering the clip to the user.

2. The computer implemented method of claim 1, wherein the method comprises recording a portion of the content with a microphone or a camera, forwarding the recorded portion of the content watched or listened to by the user or a digital representation thereof for purposes of identification of the content.

3. A computer implemented method for preparing a clip of one or more of a video or an audio content comprising the steps of: a) receiving an input from a user indicating a desire by the user to create a clip of the content; b) identifying of the media content and a specific time within the content the user is watching or listening to based on the digital content of the content or a digital signal associated with the content having identification information; c) creating the clip based on the specific time with a start and an end point; and d) delivering the clip (final clip) to the user.

4. The method of claim 3, further comprising delivering a representative clip to the user and receiving editing information from the user on the representative clip before the step of creating the and delivering the final clip to the user.

5. The method of claim 4, wherein the editing information received from the user includes changing one or more of the start or the end point of the representative clip.

6. The method of claim 5, further comprising adding additional content to the final clip not present in the representative clip due to the instructions from the user for an earlier start time or a later end time.

7. The method of claim 3, further comprising a step of synchronizing with the content before the step of receiving the input from the user indicating the desire by the user to create the clip.

8. The method of claim 3, further comprising a step of synchronizing with the content upon receiving the input from the user indicating the desire by the user to create the clip.

9. The method of claim 3, wherein the identifying is carried out by listening to the digital signal from a provider of the content.

10. The method of claim 3, wherein the identifying step is carried out by making a comparison with a library of pre-processed content.

11. The method of claim 10, wherein the identifying is carried out by an Automatic Content Recognition (ACR) program using one or more of pre-processed video and audio in the library as a reference for identification.

12. The method of claim 11, wherein the library contains reference frames and fingerprints of the content, and the reference frames and the fingerprints correspond to each other with a time code.

13. The method of claim 12, wherein the identifying step is carried out by
a) fingerprinting the content, the fingerprinting carried out on the user's device.
b) comparing the fingerprints of the content with preexisting fingerprints on the library, the comparing step carried out on a server.

14. The method of claim 13, wherein the content is live streamed, and the method further comprises continually processing the live content and updating the library with one or more of the processed video and audio of the content.

15. The method of claim 3, wherein the content is selected from the group consisting of one or more of a looping visual, video segment, virtual reality footage, 3-D footage still image, or audio sample, and a combination thereof.

16. The method of claim 4, further comprising providing a graphic user interface with controls to the user configured to allow the user to adjust the start and the send point of the representative clip.

17. The method of claim 4, wherein the final clip or the representative clip can be created from content residing on the user's electronic device.

18. The method of claim 4, further comprising receiving content on the device of the user to create a buffer of the content on the user's device before receiving the input from the user to create the clip.

19. A system for preparing a clip of a media content, the system comprising:
a. a content detection module for forwarding content for identification;
b. a content identification module for identifying the content;
c. a clip creation module for creating a representative and a final clip based on the identification and time the content;
d. a content display module for displaying the representative and the final clip to the user;
wherein the system provides the representative clip to the user based on an input by the user, and provides the final clip to the user after receiving editing instructions from the user on the representative clip.

20. The system of claim 19, further comprising a library with digital fingerprints on pre-existing content, wherein the identifying is carried out by comparing the content with the digital fingerprint of the pre-existing content in the library.
